(19) United States
(12) Patent Application Publication
(10) Pub. No.: US 2025/0114918 A1
(43) Pub. Date: Apr. 10, 2025

(54) Adjustable Wrench Device

(71) Applicant: Blake Deron, Richwood, LA (US)

(72) Inventor: Blake Deron, Richwood, LA (US)

(21) Appl. No.: 18/377,567

(22) Filed: Oct. 6, 2023

(51) Int. Cl. B25B 13/48

(52) U.S. Cl. CPC B25B 13/481

(57) ABSTRACT

An adjustable wrench device includes a wrench that has a head and a handle extending away from the head. The head including a fixed jaw and a movable jaw and the movable jaw is slidable toward or away from the fixed jaw to engage fasteners of varying dimensions. An adjustment mechanism is movably integrated into the wrench and the adjustment mechanism is in mechanical communication with the movable jaw thereby facilitating the adjustment mechanism to urge the movable jaw toward or away from the fixed jaw. The adjustment mechanism includes a knob that is rotatably disposed on the handle to facilitate a user to grip the knob when the head is positioned in a tight location thereby facilitating the user to adjust the movable jaw while the head is positioned in the tight location.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to wrench devices and more particularly pertains to a new wrench device for facilitating an adjustable wrench to be adjusted when a head of the adjustable wrench is positioned in a difficult to access location. The device includes an adjustable wrench that includes a fixed jaw and a movable jaw and an adjustment mechanism that is in mechanical communication with the movable jaw. The adjustment mechanism includes a knob rotatably disposed on a distal end of a handle of the wrench to facilitate the movable jaw to be adjusted when the fixed jaw and the movable jaw are positioned in a difficult to access location.

### (2) Description of Related Art Including Information Disclosed Under 37 CFR 1.97 and 1.98.

The prior art relates to wrench devices including a variety of adjustable wrenches that each at least includes a movable jaw that is urgeable upwardly toward or downwardly away from a fixed jaw and a knob that is located on a handle of the wrench for adjusting the movable jaw. In no instance does the prior art disclose an adjustable wrench that includes a movable jaw that is laterally slidable toward or away from a fixed jaw and a knob that is located on a handle of the wrench for adjusting the movable jaw.

### BRIEF SUMMARY OF THE INVENTION

An embodiment of the disclosure meets the needs presented above by generally comprising a wrench that has a head and a handle extending away from the head. The head including a fixed jaw and a movable jaw and the movable jaw is slidable toward or away from the fixed jaw to engage fasteners of varying dimensions. An adjustment mechanism is movably integrated into the wrench and the adjustment mechanism is in mechanical communication with the movable jaw thereby facilitating the adjustment mechanism to urge the movable jaw toward or away from the fixed jaw. The adjustment mechanism includes a knob that is rotatably disposed on the handle to facilitate a user to grip the knob when the head is positioned in a tight location thereby facilitating the user to adjust the movable jaw while the head is positioned in the tight location.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an adjustable wrench device according to an embodiment of the disclosure.

FIG. 2 is a front view of an embodiment of the disclosure.

FIG. 3 is a left side view of an embodiment of the disclosure.

FIG. 4 is a right side view of an embodiment of the disclosure.

FIG. 5 is a cross sectional view taken along line 5-5 of FIG. 4 of an embodiment of the disclosure.

FIG. 6 is a cross sectional view taken along line 6-6 of FIG. 4 of an embodiment of the disclosure.

FIG. 7 is a perspective in-use view of an embodiment of the disclosure.

### DETAILED DESCRIPTION OF THE INVENTION

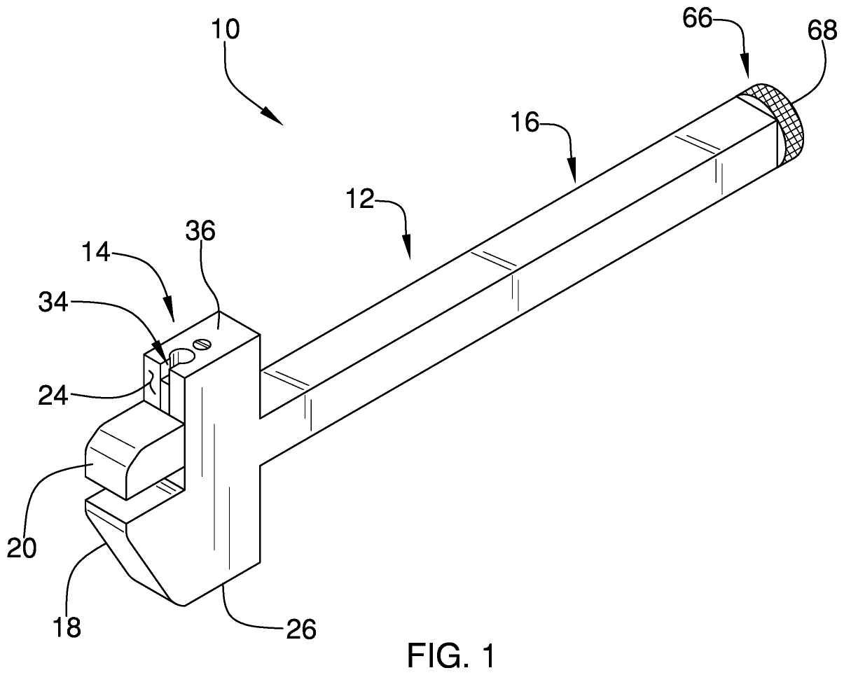

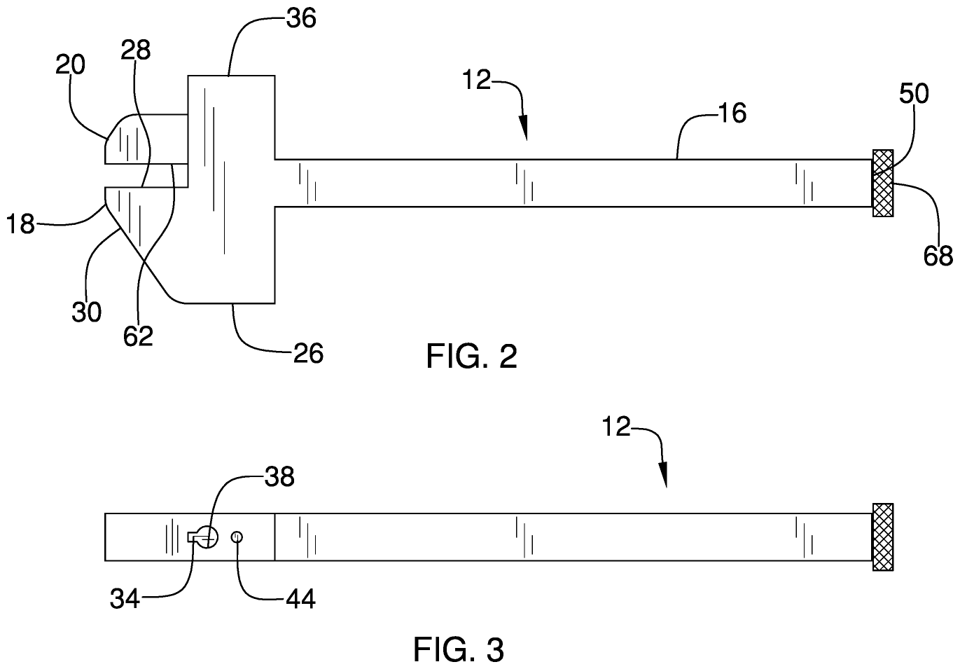

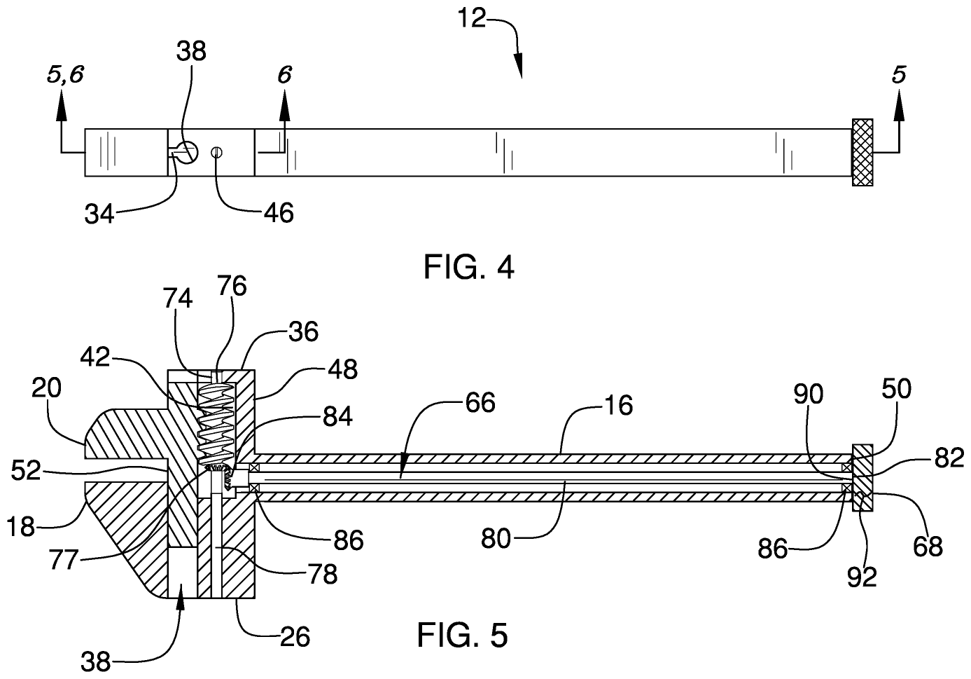

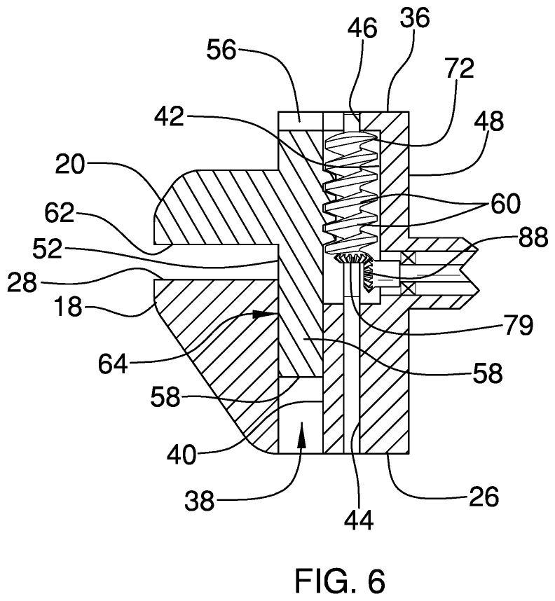

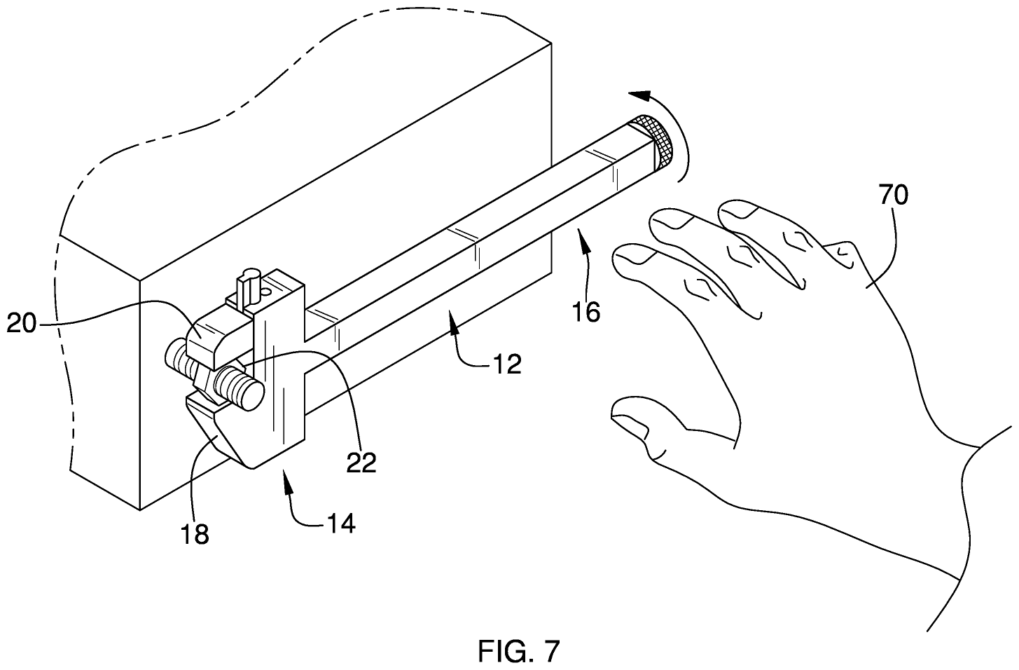

With reference now to the drawings, and in particular to FIGS. 1 through 7 thereof, a new wrench device embodying the principles and concepts of an embodiment of the disclosure and generally designated by the reference numeral 10 will be described.

As best illustrated in FIGS. 1 through 7, the adjustable wrench device 10 generally comprises a wrench 12 that has a head 14 and a handle 16 extending away from the head 14; the head 14 includes a fixed jaw 18 and a movable jaw 20. The movable jaw 20 is slidable toward or away from the fixed jaw 18 thereby facilitating the fixed jaw 18 and the movable jaw 20 to engage fasteners 22 of varying dimensions. The fasteners 22 may comprise nuts, bolts or other type of fasteners 22 that are commonly tightened or loosened with wrenches.

The fixed jaw 18 extends upwardly from a top surface 24 of the head 14 at a point located adjacent to a first lateral side 26 of the head 14. The fixed jaw 18 has a first lateral surface 28 that is perpendicularly oriented with the top surface 24 and a second lateral surface 30 sloping downwardly between the first lateral surface 28 and the first lateral side 26 of the head 14. Furthermore, the first lateral surface 28 can abut a respective one of a plurality of intersecting sides 32 of the fastener 22.

The head 14 has a slot 34 extending downwardly into the top surface 24 and the slot 34 extends between the first lateral side 26 of the head 14 and a second lateral side 36 of the head 14. The slot 34 has a rounded portion 38 that is spaced downwardly from the top surface 24 of the head 14 and the rounded portion 38 has a bounding surface 40 that is concavely arcuate with respect to the top surface 24 such that the rounded portion 38 has a circular shape. The head 14 has a gear chamber 42 that is positioned within the head 14 and the gear chamber 42 is positioned beneath the rounded portion 38 of the slot 34. The gear chamber 42 is elongated along an axis which extends between the first lateral side 26 and the second lateral side 36 of the head 14 and the gear chamber 42 is positioned closer to the second lateral side 36 than the first lateral side 26. The head 14 has a first rod hole 44 extending between the first lateral side 26 of the head 14 and the gear chamber 42 and the head 14 has a second rod hole 46 extending between the second lateral side 36 of the head 14 and the gear chamber 42.

The handle 16 extends downwardly from a bottom surface 48 of the head 14 and the handle 16 is substantially hollow. The handle 16 has a distal end 50 with respect to the bottom surface 48 and the distal end 50 is open into an interior of the handle 16. Furthermore, the interior of the handle 16 is in fluid communication with the gear chamber 42 in the head 14. The movable jaw 20 has a foot 52 that is slidably positioned in the slot 34 in the top surface 24 of the head 14. The foot 52 has a first end 54 and a second end 56 and the foot 52 is elongated between the first end 54 and the second end 56. Additionally, the foot 52 has a lobe 58 that is positioned in the rounded portion 38 of the slot 34 thereby inhibiting the foot 52 from being removed from the slot 34. The movable jaw 20 is positioned closer to the second end 56 of the foot 52 than the first end 54 of the foot 52.

The movable jaw 20 has a plurality of teeth 60 which each extend downwardly from the lobe 58 on the foot 52. The teeth 60 are spaced apart from each other and are distributed from the second end 56 of the foot 52 toward the first end 54 of the foot 52. Furthermore, each of the plurality of teeth 60 extends downwardly into the gear chamber 42. The movable jaw 20 has a primary lateral surface 62 that is perpendicularly oriented with an upper surface 64 of the foot 52 and the primary lateral surface 62 faces the first lateral surface 28 of the fixed jaw 18. In this way the primary lateral surface 62 can abut a respective one of the plurality of intersecting sides 32 of the fastener 22.

An adjustment mechanism 66 is movably integrated into the wrench 12 and the adjustment mechanism 66 is in mechanical communication with the movable jaw 20 thereby facilitating the adjustment mechanism 66 to urge the movable jaw 20 toward or away from the fixed jaw 18. The adjustment mechanism 66 includes a knob 68 that is rotatably disposed on the handle 16 such that the knob 68 can be gripped by a user 70 when the head 14 is positioned in a tight location. In this way the user 70 can adjust the movable jaw 20 while the head 14 is positioned in the tight location.

The adjustment mechanism 66 comprises a worm gear 72 that is rotatably positioned within the gear chamber 42. The worm gear 72 engages each of the plurality of teeth 60 which extend downwardly from the lobe 58 of the foot 52. Additionally, the worm gear 72 has an axis of rotation that is oriented parallel to an axis extending between the first end 54 and the second end 56 of the foot 52. The movable jaw 20 is urged to travel toward the fixed jaw 18 when the worm gear 72 is rotated in a first direction and the movable jaw 20 is urged to travel away from the fixed jaw 18 when the worm gear 72 is rotated in a second direction.

The adjustment mechanism 66 includes a first shaft 74 that is coupled to and extends away from a primary end 76 of the worm gear 72 and the first shaft 74 is positioned in the first rod hole 44 in the head 14. The adjustment mechanism 66 includes a second shaft 78 that is coupled to and extends away from a secondary end 77 of the worm gear 72. The second shaft 78 is positioned in the second rod hole 46 in the head 14 and the first shaft 74 and the second shaft 78 rotatably retains the worm gear 72 in the gear chamber 42. The adjustment mechanism 66 includes a first gear 79 that is positioned around the first shaft 74 such that the first gear 79 abuts the primary end 76 of the worm gear 72.

The adjustment mechanism 66 includes a drive shaft 80 that has a lower end 82 and an upper end 84. The drive shaft 80 is positioned within the handle 16 such that the upper end 84 is positioned in the gear chamber 42 and the lower end 82 is positioned adjacent to the distal end 50 of the handle 16. The adjustment mechanism 66 includes a pair of bearings 86 that is each positioned within the handle 16. The drive shaft 80 extends through each of the pair of bearings 86 such that each of the pair of bearings 86 retains the drive shaft 80 in a preferred orientation.

The adjustment mechanism 66 includes a second gear 88 that is coupled to the upper end 84 of the drive shaft 80. The second gear 88 has a rotational axis that is perpendicularly oriented to a rotational axis of the second gear 88. Furthermore, the second gear 88 enmeshes with the first gear 79 such that the worm gear 72 rotates when the drive shaft 80 is rotated. An upper surface 90 of the knob 68 is attached to the lower end 82 of the shaft. The worm gear 72 rotates in the first direction when the knob 68 is rotated in a tightening direction. Conversely, the worm gear 72 rotates in the second direction when the knob 68 is rotated in a loosening direction. Additionally, an exterior surface 92 of the knob 68 is knurled to enhance gripping the exterior surface 92 for rotating the knob 68.

In use, the handle 16 of the wrench 12 is gripped to facilitate the head 14 of the wrench 12 to be positioned in a preferred orientation to position the fastener 22 between the fixed jaw 18 and the movable jaw 20. The knob 68 is rotated in the first direction to facilitate the fastener 22 to be enclosed between the fixed jaw 18 and the movable jaw 20. In this way the movable jaw 20 can be adjusted when the head 14 of the wrench 12 is positioned in a tight location that would not allow the user 70 to effectively reach the head 14. Thus, a variety of sizes of fasteners 22 can be broken loose, or tightened, with the wrench 12 even when the fasteners 22 are located in a difficult to reach location.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable wrench device being remotely adjustable to facilitate fitment to a fastener in a tight location, said device comprising:
a wrench having a head and a handle extending away from said head, said head including a fixed jaw and a movable jaw, said movable jaw being laterally slidable toward or away from said fixed jaw wherein said fixed jaw and said movable jaw are configured to engage fasteners of varying dimensions; and
an adjustment mechanism being movably integrated into said wrench, said adjustment mechanism being in mechanical communication with said movable jaw thereby facilitating said adjustment mechanism to urge said movable jaw toward or away from said fixed jaw, said adjustment mechanism including a knob being rotatably disposed on said handle wherein said knob is configured to be gripped by a user when said head is positioned in a tight location thereby facilitating the user to adjust said movable jaw while said head is positioned in the tight location.

2. The device according to claim 1, wherein:
said fixed jaw extends upwardly from a top surface of said head at a point located adjacent to a first lateral side of said head;
said fixed jaw has a first lateral surface being perpendicularly oriented with said top surface and a second lateral surface sloping downwardly between said first lateral surface and said first lateral side of said head wherein said first lateral surface is configured to abut a respective one of a plurality of intersecting sides of the fastener;
said head has a slot extending downwardly into said top surface, said slot extending between said first lateral side of said head and a second lateral side of said head;
said slot has a rounded portion being spaced downwardly from said top surface of said head;
said rounded portion having a bounding surface being concavely arcuate with respect to said top surface such that said rounded portion has a circular shape;
said movable jaw has a foot being slidably positioned in said slot in said top surface of said head;
said foot has a first end and a second end;
said foot is elongated between said first end and said second end;
said foot has a lobe being positioned in said rounded portion of said slot thereby inhibiting said foot from being removed from said slot;
said movable jaw has a primary lateral surface being perpendicularly oriented with an upper surface of said foot, said primary lateral surface facing said first lateral surface of said fixed jaw wherein said primary lateral surface is configured to abut a respective one of the plurality of intersecting sides of the fastener; and
said movable jaw is positioned closer to said second end of said foot than said first end of said foot.

3. The device according to claim 2, wherein:
said head has a gear chamber being positioned within said head;
said gear chamber is positioned beneath said rounded portion of said slot;
said gear chamber is elongated along an axis extending between said first lateral side and said second lateral side of said head;
said gear chamber is positioned closer to said second lateral side than said first lateral side;
said movable jaw has a plurality of teeth which each extend downwardly from said lobe on said foot, said teeth being spaced apart from each other and being distributed from said second end of said foot toward said first end of said foot;
each of said plurality of teeth extends downwardly into said gear chamber;
said head has a first rod hole extending between said first lateral side of said head and said gear chamber; and
said head has a second rod hole extending between said second lateral side of said head and said gear chamber.

4. The device according to claim 3, wherein:
said adjustment mechanism comprises a worm gear being rotatably positioned within said gear chamber;
said worm gear engages each of said plurality of teeth which extend downwardly from said lobe of said foot;
said worm gear has an axis of rotation being oriented parallel to an axis extending between said first end and said second end of said foot;
said movable jaw is urged to travel toward said fixed jaw when said worm gear is rotated in a first direction; and
said movable jaw is urged to travel away from said fixed jaw when said worm gear is rotated in a second direction.

5. The device according to claim 4, wherein said adjustment mechanism includes:
a first shaft being coupled to and extending away from a primary end of said worm gear, said first shaft being positioned in said first rod hole in said head;
a second shaft being coupled to and extending away from a secondary end of said worm gear, said second shaft being positioned in said second rod hole in said head, said first shaft and said second shaft rotatably retaining said worm gear in said gear chamber; and
a first gear being positioned around said first shaft such that said first gear abuts said primary end of said worm gear.

6. The device according to claim 3, wherein:
said handle extends downwardly from a bottom surface of said head;
said handle is substantially hollow;
said handle has a distal end with respect to said bottom surface;
said distal end is open into an interior of said handle; and
said interior of said handle is in fluid communication with said gear chamber in said head; and
said adjustment mechanism includes a drive shaft having a lower end and an upper end, said drive shaft being positioned within said handle such that said upper end is positioned in said gear chamber and said lower end is positioned adjacent to said distal end of said handle.

7. The device according to claim 6, wherein said adjustment unit includes:
a pair of bearings, each of said pair of bearings being positioned within said handle, said drive shaft extending through each of said pair of bearings such that each of said pair of bearings retains said shaft in a preferred orientation; and
a second gear being coupled to said upper end of said drive shaft, said second gear enmeshing with said first gear such that said worm gear rotates when said drive shaft is rotated.

8. The device according to claim 6, wherein:
an upper surface of said knob is attached to said lower end of said shaft;
said worm gear rotates in said first direction when said knob is rotated in a tightening direction; and.
said worm gear rotates in said second direction when said knob is rotated in a loosening direction.

9. An adjustable wrench device being remotely adjustable to facilitate fitment to a fastener in a tight location, said device comprising:
a wrench having a head and a handle extending away from said head, said head including a fixed jaw and a movable jaw, said movable jaw being laterally slidable toward or away from said fixed jaw wherein said fixed jaw and said movable jaw are configured to engage fasteners of varying dimensions, said fixed jaw extending upwardly from a top surface of said head at a point located adjacent to a first lateral side of said head, said fixed jaw having a first lateral surface being perpendicularly oriented with said top surface and a second lateral surface sloping downwardly between said first lateral surface and said first lateral side of said head wherein said first lateral surface is configured to abut a respective one of a plurality of intersecting sides of the fastener, said head having a slot extending downwardly into said top surface, said slot extending between said first lateral side of said head and a second lateral side of said head, said slot having a rounded portion being spaced downwardly from said top surface of said head, said rounded portion having a bounding surface being concavely arcuate with respect to said top surface such that said rounded portion has a circular shape, said head having a gear chamber being positioned within said head, said gear chamber being positioned beneath said rounded portion of said slot, said gear chamber being elongated along an axis extending between said first lateral side and said second lateral side of said head, said gear chamber being positioned closer to said second lateral side than said first lateral side, said head having a first rod hole extending between said first lateral side of said head and said gear chamber, said head having a second rod hole extending between said second lateral side of said head and said gear chamber, said handle extending downwardly from a bottom surface of said head, said handle being substantially hollow, said handle having a distal end with respect to said bottom surface, said distal end being open into an interior of said handle, said interior of said handle being in fluid communication with said gear chamber in said head, said movable jaw having a foot being slidably positioned in said slot in said top surface of said head, said foot having a first end and a second end, said foot being elongated between said first end and said second end, said foot having a lobe being positioned in said rounded portion of said slot thereby inhibiting said foot from being removed from said slot, said movable jaw having a plurality of teeth which each extend downwardly from said lobe on said foot, said teeth being spaced apart from each other and being distributed from said second end of said foot toward said first end of said foot, each of said plurality of teeth extending downwardly into said gear chamber, said movable jaw having a primary lateral surface being perpendicularly oriented with an upper surface of said foot, said primary lateral surface facing said first lateral surface of said fixed jaw wherein said primary lateral surface is configured to abut a respective one of the plurality of intersecting sides of the fastener, said movable jaw being positioned closer to said second end of said foot than said first end of said foot; and
an adjustment mechanism being movably integrated into said wrench, said adjustment mechanism being in mechanical communication with said movable jaw thereby facilitating said adjustment mechanism to urge said movable jaw toward or away from said fixed jaw, said adjustment mechanism including a knob being rotatably disposed on said handle wherein said knob is configured to be gripped by a user when said head is positioned in a tight location thereby facilitating the user to adjust said movable jaw while said head is positioned in the tight location, said adjustment mechanism comprising:
a worm gear being rotatably positioned within said gear chamber, said worm gear engaging each of said plurality of teeth which extend downwardly from said lobe of said foot, said worm gear having an axis of rotation being oriented parallel to an axis extending between said first end and said second end of said foot, said movable jaw being urged to travel toward said fixed jaw when said worm gear is rotated in a first direction, said movable jaw being urged to travel away from said fixed jaw when said worm gear is rotated in a second direction;
a first shaft being coupled to and extending away from a primary end of said worm gear, said first shaft being positioned in said first rod hole in said head;
a second shaft being coupled to and extending away from a secondary end of said worm gear, said second shaft being positioned in said second rod hole in said head, said first shaft and said second shaft rotatably retaining said worm gear in said gear chamber;
a first gear being positioned around said first shaft such that said first gear abuts said primary end of said worm gear;
a drive shaft having a lower end and an upper end, said drive shaft being positioned within said handle such that said upper end is positioned in said gear chamber and said lower end is positioned adjacent to said distal end of said handle;
a pair of bearings, each of said pair of bearings being positioned within said handle, said drive shaft extending through each of said pair of bearings such that each of said pair of bearings retains said shaft in a preferred orientation; and
a second gear being coupled to said upper end of said drive shaft, said second gear enmeshing with said first gear such that said worm gear rotates when said drive shaft is rotated; and
wherein an upper surface of said knob is attached to said lower end of said shaft, said worm gear rotating in said first direction when said knob is rotated in a tightening direction, said worm gear rotating in said second direction when said knob is rotated in a loosening direction.
